(19) United States
(12) Patent Application Publication
(10) Pub. No.: US 2026/0004061 A1
(43) Pub. Date: Jan. 1, 2026

(54) INFORMATION PROCESSING METHOD, INFORMATION PROCESSING SYSTEM, AND COMPUTER-READABLE MEDIUM

(71) Applicant: LEGALON TECHNOLOGIES, INC., Tokyo (JP)

(72) Inventors: Takahiko KAI, Tokyo (JP); Takakazu Yanaka, Tokyo (JP)

(73) Assignee: LEGALON TECHNOLOGIES, INC., Tokyo (JP)

(21) Appl. No.: 19/321,696

(22) Filed: Sep. 8, 2025

Related U.S. Application Data
(63) Continuation of application No. PCT/JP2024/008541, filed on Mar. 6, 2024.

(30) Foreign Application Priority Data
Mar. 9, 2023 (JP) 2023-036370

(51) Int. Cl. G06F 40/194; G06F 40/109

(52) U.S. Cl. CPC G06F 40/194; G06F 40/109

(57) ABSTRACT

An information processing method is an information processing method executed by a processor, the information processing method including: acquiring first document data including first table data and second document data including second table data; specifying a correspondence between at least one first cell included in the first table data and at least one second cell included in the second table data based on similarity of contents data included in cells; and specifying a difference indicating a different part between the first table data and the second table data based on correspondence data generated by specifying the correspondence.

### CROSS-REFERENCE TO RELATED APPLICATION

The present application is a bypass continuation application based on and claims the benefit of priority from PCT Application No. PCT/JP2024/008541 filed Mar. 6, 2024, the entire contents of which are incorporated herein by reference.

### TECHNICAL FIELD

The present disclosure relates to an information processing method, an information processing system, and a computer-readable medium.

### BACKGROUND ART

Conventionally, a technique for specifying a difference between two documents by computer processing is known.

For example, a document difference display program described in Japanese Patent Laid-Open No. 2015-204076 (Patent Literature 1) acquires structured document information (for example, document information in an extensible markup language (XML) format) of a plurality of designated consecutive versions, and extracts a difference between preceding and subsequent versions of the structured document information.

### SUMMARY

An information processing method according to an embodiment of the present invention is an information processing method executed by a processor, the information processing method including: acquiring first document data including first table data and second document data including second table data; specifying a correspondence between at least one first cell included in the first table data and at least one second cell included in the second table data based on similarity of contents data included in cells; and specifying a difference indicating a different part between the first table data and the second table data based on correspondence data generated by specifying the correspondence.

According to an embodiment of the present invention, it is possible to specify a point of difference between table data in tabular form included in document data.

### BRIEF DESCRIPTION OF DRAWINGS

FIG. 1 is a diagram illustrating a configuration of an information processing system 100 according to an embodiment of the present invention.

FIG. 2 is a diagram illustrating an example of document data stored in a storage unit 110.

FIG. 3 illustrates an example of table data as a target of correspondence specifying processing.

FIG. 4 is a diagram illustrating a correspondence between at least one first representative cell and at least one second representative cell.

FIG. 5 is a diagram illustrating a correspondence between at least one first belonging cell and at least one second belonging cell.

FIG. 6 is a diagram illustrating an example of correspondence specifying processing in a case where a vertically combined cell is included.

FIG. 7 is a diagram illustrating an example of correspondence specifying processing in a case where a plurality of identical contents cells are included.

FIG. 8 is a diagram illustrating an example of correspondence data stored in the storage unit 110.

FIG. 9 is a diagram illustrating an example of display data displayed on a user terminal 200.

FIG. 10 is a flowchart illustrating an example of processing in the information processing system 100.

FIG. 11 is a diagram illustrating an example of a hardware configuration of a computer 1100.

### DESCRIPTION

In the document difference display program described in Patent Literature 1, for example, there is no mention of appropriately extracting a point of difference in a case where a document includes table data in tabular form.

Therefore, an object of an embodiment of the present invention is to specify a point of difference between table data in tabular form included in document data.

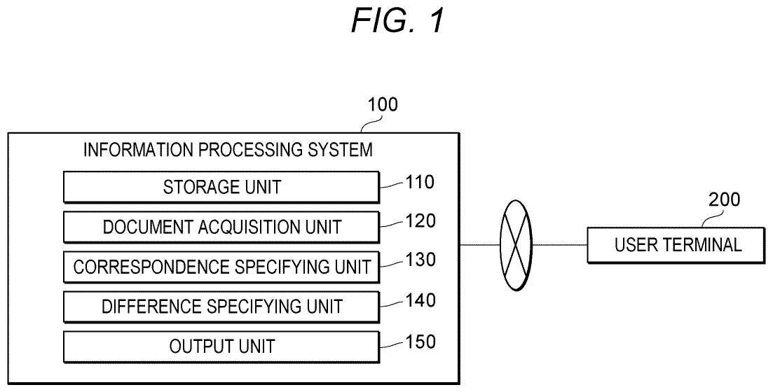

An embodiment of the present invention will be described with reference to the accompanying drawings. FIG. 1 is a diagram illustrating a configuration of an information processing system 100 according to an embodiment of the present invention. The information processing system 100 is communicably connected to a user terminal 200 via a network such as the Internet.

The information processing system 100 may be an information processing system that acquires first document data including first table data and second document data including second table data, specifies a correspondence between a cell included in the first table data and a cell included in the second table data based on similarity of contents data included in the cells, and specifies a difference indicating a different part between the first table data and the second table data. In addition, the information processing system 100 may output display data for displaying at least one of the first table data and the second table data with the difference highlighted. Details of the information processing system 100 will be described later.

The user terminal 200 may be a computer used by a user, and is a smartphone, a tablet terminal, a personal computer, or the like.

The user terminal 200 may provide the first document data and the second document data to the information processing system 100 according to the operation of the user. In addition, the user terminal 200 may acquire the display data from the information processing system 100 according to the operation of the user, and display at least one of the first table data and the second table data with the difference highlighted.

Note that, although one user terminal 200 is illustrated in FIG. 1, a plurality of user terminals 200 may be used.

Next, details of the information processing system 100 will be described. The information processing system 100 may include a storage unit 110, a document acquisition unit 120, a correspondence specifying unit 130, a difference specifying unit 140, and an output unit 150. Each unit illustrated in FIG. 1 can be implemented, for example, by use of a storage area or by a processor executing a program stored in the storage area.

The storage unit 110 of the present embodiment may store information to be processed in the information processing system 100. The storage unit 110 can store, for example, document data and correspondence data to be described later.

The document acquisition unit 120 of the present embodiment may acquire first document data including first table data and second document data including second table data, and store the first document data and the second document data in the storage unit 110.

The document data (for example, the first document data and the second document data) may be data related to a document including at least table data in tabular form, which is processed by the information processing system 100.

The second document data may be, for example, document data generated based on the first document data. That is, the second document data may be document data generated by editing the first document data, or may be document data generated by further editing the document data generated by editing the first document data.

In addition, the document data may be a legal document. Here, the legal document may be, for example, a bylaw or a contract. The bylaw or the contract may be, for example, an electronic document created by predetermined electronic document creation software, or an electronic document obtained by digitization of a contract of a paper medium using a predetermined image analysis technology (for example, an optical character recognition (OCR) technology). The bylaw or the contract may be, for example, a document including a clause and generating a predetermined legal effect, and also include an application form, a memorandum, and the like.

The bylaw or the contract may include not only a document agreed to by both parties but also a document that is being confirmed by both parties (that is, a draft of the bylaw or the contract), a document that has been exchanged between the parties but has not reached an agreement, or a template document prepared for reference in a contract or the like with another party. In the description of the present embodiment, unless otherwise specified, the bylaw or the contract includes not only a document agreed to by both parties but also a document that is being confirmed by both parties (that is, a draft of the bylaw or the contract), a document that has been exchanged between the parties but has not reached an agreement, or a template document prepared for reference in a contract or the like with another party.

The table data (for example, the first table data and the second table data) may be data related to a table. The table data may be, for example, data in which each cell is associated with contents data included in the cell.

The table data may be, for example, data of a table in which targets, ranges, and the like of legal effects generated by document data are organized for each item. That is, the table data may be table data in which details of a contract (for example, the contract start date, the contract end date, and the amount of the contract) may be organized for each item. In addition, in a case where the document data is contract data related to transactions or lease of real estate, the table data may be, for example, table data in which details of the property and the contract (for example, the address, the occupied area, the start date of the lease, the end date of the lease, and the rent of the property) may be organized for each item. In addition, in a case where the document data is contract data related to a deposit contract, the table data may be table data in which a list of items as targets of the deposit contract is organized.

Conventionally, table data has been compared by visual inspection of a user in some cases. In particular, table data included in a legal document may be table data in which a wide variety of items are organized, and a small difference in contents may lead to a large change in legal effect. Thus, there may be a limit to the visual inspection of a user. Therefore, the information processing system 100 can improve the convenience in the inspection of a user by specifying a difference between table data included in document data (in particular, for example, document data of a legal document).

The document acquisition unit 120 may acquire document data, for example, from the user terminal 200. Furthermore, the document acquisition unit 120 may acquire document data from an external information processing system (for example, the cloud), for example, in response to an instruction of the user via the user terminal 200.

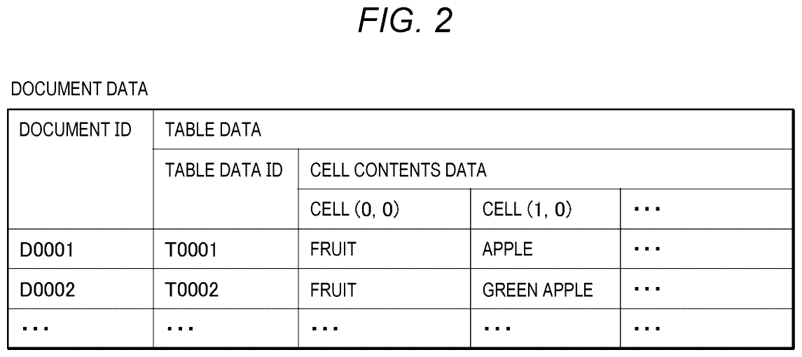

FIG. 2 is a diagram illustrating an example of document data stored in the storage unit 110. The document data stored in the storage unit 110 may include, for example, a document ID and table data. The table data may further include, for example, a table data ID and cell contents data.

The document ID may be information for identifying document data stored in the storage unit 110.

The table data ID may be information for identifying table data included in document data. The cell contents data may be information indicating contents included in each cell included in table data. The cell contents data may be, for example, character data indicating a character or image data indicating an image, and may further include table data.

The document data stored in the storage unit 110 may further include document contents information. The document contents information may be, for example, data indicating contents described in a part other than table data, and include, for example, character data.

The correspondence specifying unit 130 of the present embodiment may specify a correspondence between at least one first cell included in the first table data and at least one second cell included in the second table data based on similarity of contents data included in the cells, and store the generated correspondence data in the storage unit 110.

In addition, specifying the correspondence by the correspondence specifying unit 130 may include specifying a non-corresponding cell that does not correspond between the first table data and the second table data among the cells included in the first table data and the second table data. In other words, for example, for each of the cells included in the first table data, the correspondence specifying unit 130 may associate the cell with a cell included in the corresponding second table data or specify the cell as a non-corresponding cell, and, for each of the cells included in the second table data, may associate the cell with a cell included in the corresponding first table data or specify the cell as a non-corresponding cell.

Next, the correspondence specifying processing by the correspondence specifying unit 130 will be specifically described.

First, the correspondence specifying unit 130 may execute first processing of associating at least one first representative cell included in a predetermined column of the first table data and at least one second representative cell included in a predetermined column of the second table data based on similarity of contents data included in the cells.

Here, the predetermined columns may be, for example, leftmost columns. That is, the at least one first representative cell may be a cell belonging to the leftmost column of the first table data, and the at least one second representative cell may be a cell belonging to the leftmost column of the second table data.

Note that the predetermined column in the first table data and the predetermined column in the second table data may be columns having different ordinal numbers from the left end. That is, for example, the first representative cell may belong to the leftmost column, and the second representative cell may belong to the second column from the left.

The correspondence specifying unit 130 may associate at least one first representative cell and at least one second representative cell based on the similarity of the contents data included in the cells.

Specifically, the correspondence specifying unit 130 may evaluate similarity between contents data (for example, character data) included in the first representative cell and contents data (for example, character data) included in the second representative cell, and associate a combination of cells having the highest similarity as corresponding cells.

Note that the evaluation of the similarity of the contents data by the correspondence specifying unit 130 may be, for example, evaluation according to the Levenshtein distance.

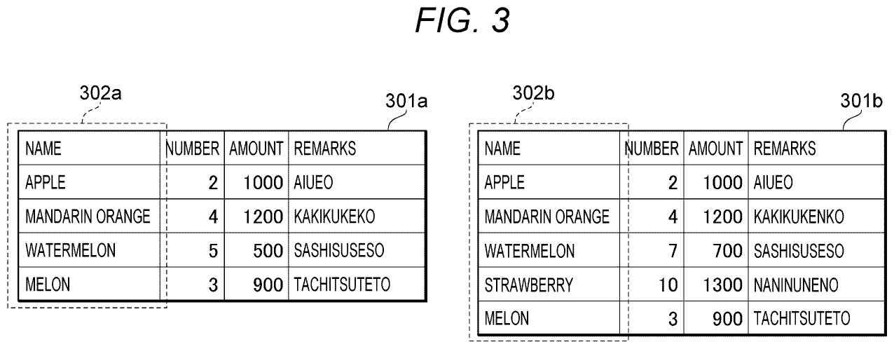

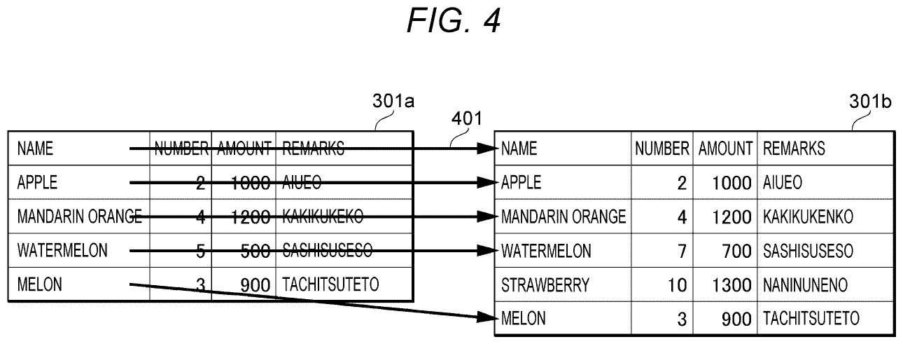

This will be specifically described with reference to FIGS. 3 and 4.

FIG. 3 illustrates an example of table data as a target of the correspondence specifying processing. First table data 301a is first table data included in a first document, and second table data 301b is second table data included in a second document.

As illustrated in FIG. 3, the first table data 301a and the second table data 301b may be similar table data, but may be partially different. For example, in the FIG. 3, the second table data 301b has a row with the name “strawberry”, whereas the first table data 301a has no row with the name “strawberry”, and the structures of the table data (for example, the numbers of rows or the numbers of columns) are different. In addition, the contents of the cells in the number column, the amount column, and the remarks column may be also partially different. For example, even in a case where the structures of the table data are different or the contents of the cells are different as in the first table data 301a and the second table data 301b, the correspondence specifying unit 130 can associate each cell of the two sets of table data.

First, the correspondence specifying unit 130 may associate at least one first representative cell included in a predetermined column (for example, the leftmost column) of the first table data 301a and at least one second representative cell included in a predetermined column of the second table data 301b.

Specifically, the correspondence specifying unit 130 may compare a first column 302a, which is the leftmost column of the first table data 301a, with a second column 302b, which is the leftmost column of the second table data 301b, and execute the first processing of associating at least one first representative cell included in the first column 302a and at least one second representative cell included in the second column 302b based on similarity of contents data included in the cells.

In this case, the at least one first representative cell is cells included in the first column 302a, and is “name”, “apple”, “mandarin orange”, “watermelon”, and “melon”. Furthermore, the at least one second representative cell is cells included in the second column 302b, and is “name”, “apple”, “mandarin orange”, “watermelon”, “strawberry”, and “melon”.

The correspondence specifying unit 130 may calculate similarity between each of the at least one first representative cell and contents data included in the at least one second representative cell in a round-robin manner. That is, first, the correspondence specifying unit 130 may calculate similarity between the first representative cell “name” and contents data included in the plurality of second representative cells (“name”, “apple”, “mandarin orange”, “watermelon”, “strawberry”, and “melon”). The correspondence specifying unit 130 then may specify, for example, the second representative cell having the highest similarity as a cell corresponding to the first representative cell “name”. In this case, since the contents data of the first representative cell “name” matches the contents data of the second representative cell “name”, the similarity is 100%, and the correspondence specifying unit 130 may specify the second representative cell “name” as a cell corresponding to the first representative cell “name”. Subsequently, similarly, the correspondence specifying unit 130 may specify a second representative cell corresponding to another first representative cell (for example, “apple”).

FIG. 4 is an example of a diagram illustrating a correspondence between at least one first representative cell and at least one second representative cell. In this example, as indicated by an arrow 401, the first representative cell “name” and the second representative cell “name” are associated with each other. The same may apply to the other first representative cells. In this example, the second representative cell “strawberry” has no corresponding first representative cell, and thus is a non-corresponding cell.

Subsequently, the correspondence specifying unit 130 may execute second processing of associating at least one first belonging cell included in a row of at least one first representative cell and at least one second belonging cell included in a row of at least one second representative cell associated with the at least one first representative cell based on similarity of contents data included in the cells.

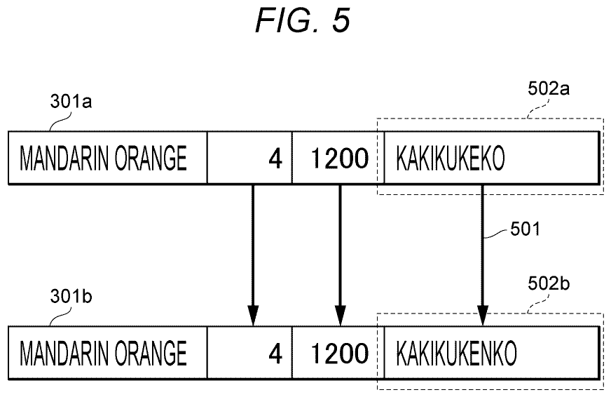

This will be specifically described with reference to FIG. 5.

FIG. 5 is an example of a diagram illustrating a correspondence between at least one first belonging cell and at least one second belonging cell. In this example, as indicated by an arrow 501, a first belonging cell 502a “kakikukeko” and a second belonging cell 502b “kakikukenko” are associated with each other. The same may apply to the other first belonging cells.

Note that the row numbers or the column numbers of the associated cells (the representative cells and the belonging cells) may be different row numbers or column numbers. That is, even in the first table data and the second table data between which there is no difference in the contents data of the cells and there is a difference in the positional relationship of the cells, the correspondence specifying unit 130 can associate cells at different positions based on the contents data, and the difference specifying unit 140 to be described later can more appropriately specify the difference.

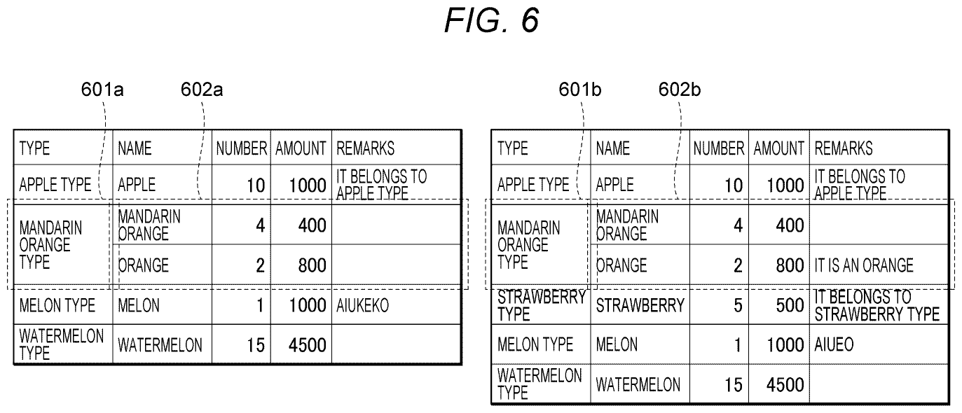

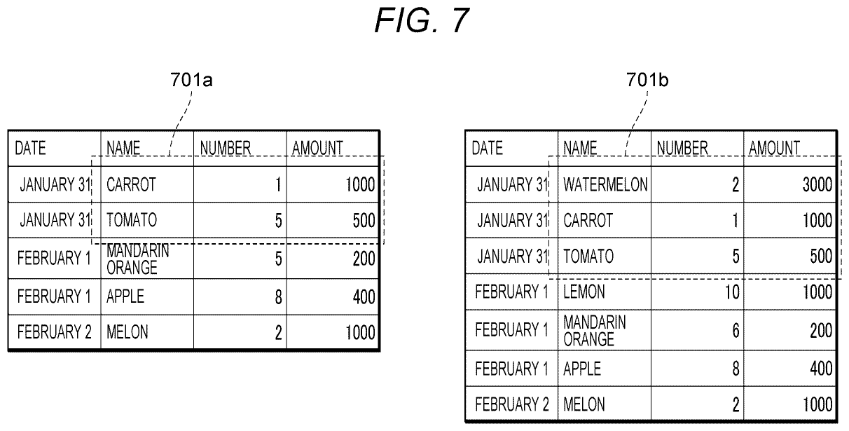

In addition, the correspondence specifying unit 130 can execute third processing of regarding table data including a plurality of cells located on the right of a predetermined cell as the first table data or the second table data and executing the first processing and the second processing. A specific example of the third processing will be described with reference to FIGS. 6 and 7.

FIG. 6 is a diagram illustrating an example of correspondence specifying processing in a case where a vertically combined cell is included.

In the first processing and the second processing, in a case where at least one cell of at least one first representative cell and at least one second representative cell is a vertically combined cell obtained by combining cells vertically arranged over a plurality of rows, the correspondence specifying unit 130 may execute the third processing of regarding table data including a plurality of cells located on the right of the vertically combined cell as the first table data or the second table data, and executing the first processing and the second processing.

As illustrated in FIG. 6, in this example, a first representative cell 601a and a second representative cell 601b are vertically combined cells.

First, the correspondence specifying unit 130 may associate the first representative cell 601a and the second representative cell 601b by the first processing.

Subsequently, the correspondence specifying unit 130 may regard a plurality of cells 602a and 602b located on the right of the vertically combined cells as the first table data and the second table data, respectively, and execute the third processing. That is, the correspondence specifying unit 130 may first perform the first processing with “mandarin orange” and “orange” in a predetermined column (for example, the leftmost column) as representative cells, and then perform the second processing on belonging cells.

Note that the correspondence specifying unit 130 may perform the third processing after performing the first processing and the second processing. That is, the vertically combined cells may not be representative cells of the first table data and the second table data.

In a case where the third processing is not performed, for example, in the first table data, the cell “mandarin orange” may be processed by being recognized as a cell belonging to the vertically combined cell “mandarin orange type”, but the cell “orange” may not be recognized as a cell belonging to the vertically combined cell “mandarin orange type”, and in this case, the cell “orange” is a non-corresponding cell. In this case, although the cell “orange” in the first table data and the cell “orange” in the second table data are cells corresponding to each other, both cells are recognized as non-corresponding cells. This is because, for example, the row number of the vertically combined cell may be managed as the row number of the uppermost cell in the vertically combined cell. Therefore, by executing the third processing, the correspondence specifying unit 130 can associate the cell “orange” in the first table data and the cell “orange” in the second table data with each other.

Next, FIG. 7 is a diagram illustrating an example of correspondence specifying processing in a case where a plurality of identical contents cells are included.

In the first processing and the second processing, in a case where at least one of at least one first representative cell and at least one second representative cell includes a plurality of identical contents cells including identical contents data in the cells, the correspondence specifying unit 130 may execute the third processing of regarding table data including a plurality of cells located on the right of the plurality of identical contents cells as the first table data or the second table data, and executing the first processing and the second processing.

As illustrated in FIG. 7, in this example, in the “date” columns, there are a plurality of identical contents cells having the contents of “January 31”. Therefore, the correspondence specifying unit 130 may regard a plurality of cells 701a and 701b located on the right of the plurality of identical contents cells as the first table data and the second table data, respectively, and perform the first processing and the second processing. That is, the correspondence specifying unit 130 may regard “carrot”, “tomato”, and “watermelon” in a predetermined column (for example, the leftmost column) as a representative column and perform the first processing. Subsequently, the second processing may be performed on belonging cells.

Note that the correspondence specifying unit 130 may perform the third processing after performing the first processing and the second processing. The plurality of identical contents cells may not be representative cells of the first table data and the second table data. In addition, contents data included in the identical contents cells may be blank. That is, the plurality of identical contents cells may be a plurality of blank cells.

In a case where the third processing is not performed, for example, in the first table data, the identical contents cells may be associated in order from the top. That is, in this case, the cell “January 31” that first appears in the first table data and the cell “January 31” that first appears in the second table data are associated with each other by the first processing. In this case, the cell “carrot” belonging to the cell “January 31” that first appears in the first table data and the cell “watermelon” belonging to the cell “January 31” that first appears in the second table data are associated with each other by the second processing. However, in order to more appropriately specify the correspondence, it may be preferable to associate the cell “January 31” that appears first in the first table data (the cell to which “carrot” belongs) and the cell “January 31” that appears second in the second table data (the cell to which “carrot” belongs). Therefore, by executing the third processing, the correspondence specifying unit 130 can associate the cell “January 31” that appears first in the first table data (the cell to which “carrot” belongs) and the cell “January 31” that appears second in the second table data (the cell to which “carrot” belongs).

As described above, the correspondence specifying unit 130 can associate cells between table data having different structures by the first processing, the second processing, and the third processing.

Note that, in the case of table data having the same structure, the correspondence specifying unit 130 may associate cells by the first processing, the second processing, and the third processing, or may associate cells having the same row number and column number.

In addition, in the case of table data having different structures, the correspondence specifying unit 130 may generate correspondence data including information indicating that the table data have different structures. As a result, the output unit 150 to be described later can output information indicating that the table data have different structures to the user terminal 200.

In addition, the correspondence specifying unit 130 may generate correspondence data including similarity data indicating similarity between corresponding cells.

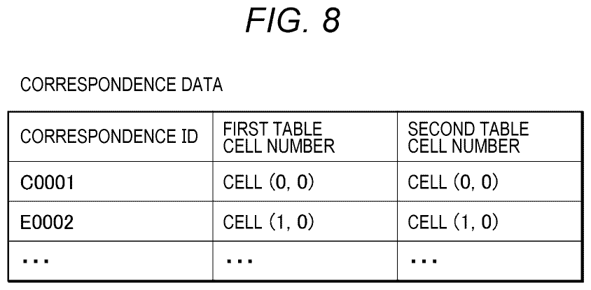

FIG. 8 is a diagram illustrating an example of correspondence data stored in the storage unit 110. The correspondence data stored in the storage unit 110 may include, for example, a correspondence ID, a first table cell number, and a second table cell number.

The correspondence ID may be information for identifying correspondence data to be processed in the information processing system 100. The first table cell number and the second table cell number may be information indicating cell numbers in the first table data and the second table data, respectively.

The correspondence data stored in the storage unit 110 may further include information indicating that the table data have different structures. Furthermore, the correspondence data stored in the storage unit 110 may further include similarity data.

The difference specifying unit 140 of the present embodiment may specify a difference indicating a different part between the first table data and the second table data based on the correspondence data.

Here, the difference may be, for example, a difference between first contents data and second contents data. That is, the difference may be a point of difference between the first contents data and the second contents data in the first cell and the second cell corresponding to each other.

In addition, the difference may be contents data included in a non-corresponding cell.

The output unit 150 of the present embodiment may output display data for displaying at least one of the first table data and the second table data with the difference highlighted to the user terminal 200.

In addition, the output unit 150 can output, to the user terminal 200, display data for displaying the first table data and the second table data side by side with the difference highlighted.

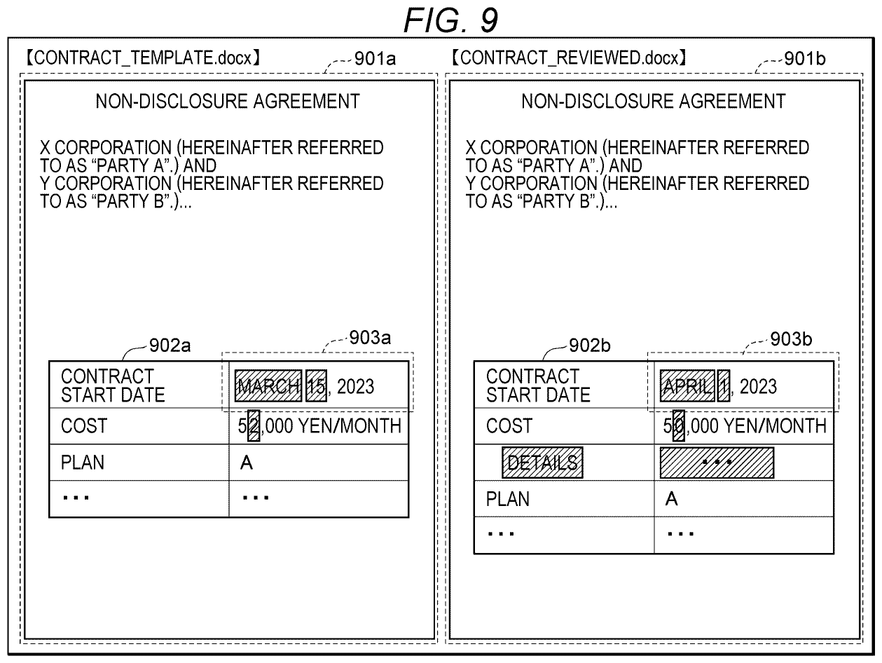

FIG. 9 is a diagram illustrating an example of display data displayed on the user terminal 200.

The screen illustrated in FIG. 9 includes a first area 901a for displaying the first document data, a second area 901b for displaying the second document data side by side with the first document data, a third area 902a for displaying the first table data, and a fourth area 902b for displaying the second table data side by side with the first table data.

As illustrated in FIG. 9, the first table data and the second table data may have different structures, and also have points of difference in contents described in the cells.

The correspondence specifying unit 130 may specify a correspondence between cells of the first table data and the second table data, and, for example, associate a cell 903a “Mar. 15, 2023” and a cell 903b “Apr. 1, 2023”.

Then, the difference specifying unit 140 may extract a difference between the cell 903a “Mar. 15, 2023” and the cell 903b “Apr. 1, 2023”. In this case, the cell 903a “Mar. 15, 2023” and the cell 903b “Apr. 1, 2023” have no difference in the numerical value of the year, but have a difference in the numerical value of the month and day. The output unit 150 may output display data for display with the difference highlighted to the user terminal 200.

The user terminal 200 then may highlight the difference. At this time, the user terminal 200 can display a screen as illustrated in FIG. 9 based on the display data output by the output unit 150. That is, for example, the numerical values of the month and day having the difference may be highlighted.

The highlighting of the difference may include, for example, highlighting by surrounding the difference with a rectangle having a predetermined color, a predetermined pattern, a predetermined transparency, or the like, or displaying the difference in a predetermined color. In addition, the mode of highlighting the difference may be the same mode in the first table data and the second table data, or may be different modes (for example, display in different colors). Note that the mode of highlighting the difference is not limited to the mode in FIG. 9 and the above modes.

In addition, the output unit 150 may output display data for displaying both the first document data and the second document data, or may output display data for displaying either the first document data or the second document data.

Furthermore, the output unit 150 may output display data that can hide the highlighting of the difference according to the operation of the user on the user terminal 200.

In addition, in a case where the structures of the first table data and the second table data are different from each other, the output unit 150 may output display data indicating that the structures of the first table data and the second table data are different from each other. As a result, by referring to the display indicating that the structures of the first table data and the second table data are different from each other, the user can compare a specific point of difference between the first table data and the second table data as necessary without comparing the first table data and the second table data to inspect whether the structures are different from each other, which improves the convenience of the user.

Furthermore, the output unit 150 may output display data for highlighting according to the contents of the difference. That is, the output unit 150 may output display data for highlighting a difference in an important item in the table data in a more emphasized manner and highlighting a difference in an unimportant item in the table data in a more simplified manner. As a result, the user can more easily grasp a point of difference in an important item.

Note that, in this case, the information processing system 100 may determine whether the item is an important item in the table data, for example, based on a setting determined in advance by an administrator of the information processing system 100. At this time, the administrator of the information processing system 100 may perform the above setting according to the property of the table data and the property of the document data including the table data. That is, for example, in a case where the document data is a contract, and the table data is table data indicating details of the contract, for example, “amount of contract” may be set as an important item.

Furthermore, the output unit 150 may output display data for highlighting according to the degree of difference. That is, in a case where the number of characters corresponding to the difference is a certain number or more, the output unit 150 may output display data for performing more emphasized highlighting. As a result, the user can more easily grasp a large point of difference.

The table data-related processing in the information processing system 100 (in particular, the document acquisition unit 120, the correspondence specifying unit 130, the difference specifying unit 140, and the output unit 150) has been described. The table data-related processing may have a particularly advantageous effect, for example, in a case where the first document data is document data of a template (for example, a format commonly used by users or in the industry) and the second document data is document data obtained by editing the template.

Specifically, a user of the information processing system 100 may provide, for example, the first document data including the first table data to another person (for example, a counterparty of a contract who exchanges document data with the user). The other person may edit the first document data. At this time, for example, the other person may create the second document data including the second table data obtained by describing predetermined contents in a blank of the first table data and correcting the structure of the first table data or the contents described in the cells. The other person then may provide the second document data to the user of the information processing system 100. The user may specify a difference between the first table data and the second table data through the table data-related processing of the information processing system 100 and confirm the difference. As a result, the user can visually grasp the contents edited by the other person, that is, the point of difference between the table data.

In a case where the document data (the first document data and the second document data) is, for example, a legal document such as a contract, the information processing system 100 may further perform contract type determination processing, description contents review processing, and display processing based on the document data. Note that, in a case where the document data is not a legal document, the information processing system 100 may perform document type determination processing, description contents review processing, and display processing according to the nature of the document.

Specifically, processing in a case where the document data is a legal document will be described.

The information processing system 100 (for example, in particular, a type determination processing unit) may determine the type of a contract indicated by the document data based on the document data, and output type information indicating the type of the contract. The contract type may be, for example, an “outsourcing contract”, a “non-disclosure agreement”, a “lease contract”, or a “deposit contract”. For example, the information processing system 100 may output the type information based on the contents described in the document data, or may output the type information based on the presence or absence of table data included in the document data, the structure of the table data, the contents described in the table data, or the difference specified by the difference specifying unit 140. Specifically, for example, in a case where the table data includes an item related to “rent”, the information processing system 100 may determine that the type of the document data including the table data is a “lease contract”. As a result, the information processing system 100 can determine the type of the document data (for example, document data of a legal document) based on the contents and the difference of the table data.

The information processing system 100 (for example, in particular, a review processing unit) may perform review processing on the description contents of the document data based on the document data, and output review result information indicating a review result. Here, the review processing may be, for example, evaluation and correction proposal for the contents of words (for example, terms) included in the document data, and proposal for words (for example, terms) not included in the document data. Furthermore, the criteria for the review processing may be criteria set in advance by the administrator of the information processing system 100 (for example, a general or ideal contract template), criteria set in advance by the user of the information processing system 100 (for example, a template of a contract in the company or industry to which the user belongs (so to speak, an internal standard contract), or a combination thereof.

For example, the information processing system 100 may perform the review processing based on the contents described in the document data, or may perform the review processing based on the presence or absence of table data in the document data, the structure of the table data, the contents described in the data, or the difference specified by the difference specifying unit 140. Specifically, in a case where the “rent” item in the first table data is “50,000 yen/month” and the “rent” item in the second table data is “5,000 yen/month”, the information processing system 100 may perform review processing of evaluating that the difference in the “rent” item is a mistake of the user and review processing of proposing correction of the mistake. As a result, the information processing system 100 can perform the review processing on the document data (for example, document data of a legal document) based on the contents and the difference of the table data.

The information processing system 100 (for example, in particular, a display processing unit) may display the document data on the user terminal 200 based on the results of the contract type determination processing and the description contents review processing. At this time, the information processing system 100 may simultaneously display the document data and the results of the contract type determination processing and the description contents review processing. As a result, the user can refer to the results of the contract type determination processing and the description contents review processing.

Note that the contract type determination processing, the description contents review processing, and the display processing in the information processing system 100 may be processing independent of the table data-related processing. That is, the contract type determination processing, the description contents review processing, and the display processing may be performed before, during, or after the table data-related processing, or may be performed in a case where the table data-related processing is not performed.

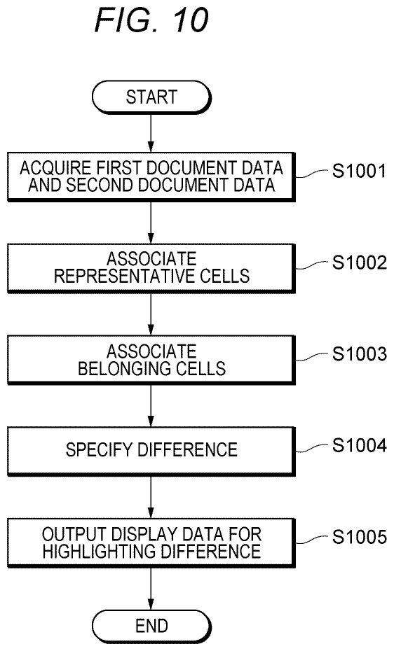

FIG. 10 is a flowchart illustrating an example of processing in the information processing system 100.

First, the document acquisition unit 120 may acquire first document data including first table data and second document data including second table data (S1001).

The correspondence specifying unit 130 may associate at least one first representative cell included in a predetermined column of the first table data and at least one second representative cell included in a predetermined column of the second table data based on similarity of contents data included in the cells (S1002). Subsequently, the correspondence specifying unit 130 may associate at least one first belonging cell included in a row of the first representative cell and at least one second belonging cell included in a row of the second representative cell based on similarity of contents data included in the cells (S1003).

The difference specifying unit 140 may specify a difference indicating a different part between the first table data and the second table data based on the correspondence data (S1004). The output unit 150 may output display data for displaying at least one of the first table data and the second table data with the difference highlighted to the user terminal 200 (S1005).

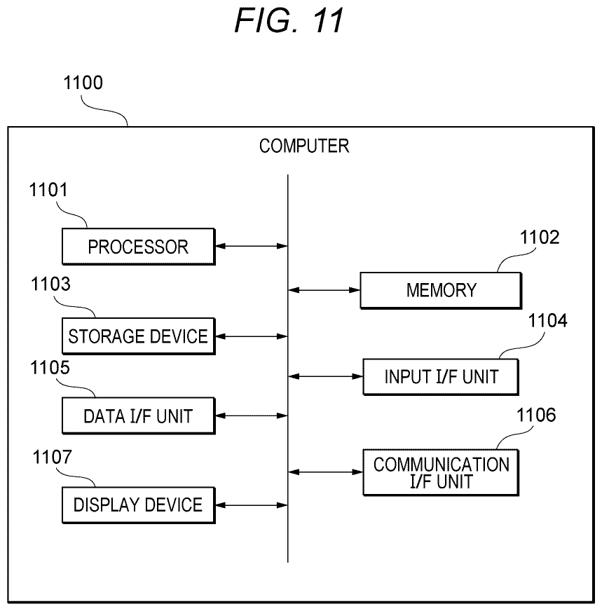

Next, an example of a hardware configuration in a case where the information processing system 100 is implemented by a computer 1100 will be described with reference to FIG. 11. FIG. 11 is a diagram illustrating an example of a hardware configuration of the computer 1100.

As illustrated in FIG. 11, the computer 1100 may include, for example, a processor 1101, a memory 1102, a storage device 1103, an input I/F unit 1104, a data I/F unit 1105, a communication I/F unit 1106, and a display device 1107.

The computer 1100 may be, for example, a server computer, a personal computer (for example, a desktop, a laptop, a tablet, or the like), a media computer platform (for example, a cable, a satellite set-top box, a digital video recorder, or the like), a handheld computer device (for example, a PDA, an e-mail client, or the like), or another type of computer or communication platform.

The processor 1101 may be a control unit that controls various types of processing in the computer 1100 by executing a program stored in the memory 1102.

The memory 1102 may be, for example, a storage medium such as a random access memory (RAM). The memory 1102 temporarily stores a program code of a program executed by the processor 1101 and data required at the time of executing the program.

The storage device 1103 may be, for example, a nonvolatile storage medium such as a hard disk drive (HDD) or a flash memory. The storage device 1103 stores an operating system and various programs for implementing the above configurations.

The input I/F unit 1104 may be a device for receiving an input from a user. The input I/F unit 1104 may be, for example, a keyboard, a mouse, a touch panel, various sensors, a wearable device, or the like. The input I/F unit 1104 may be connected to the computer 1100 via, for example, an interface such as a universal serial bus (USB).

The data I/F unit 1105 may be a device for inputting data from the outside of the computer 1100. The data I/F unit 1105 may be, for example, a drive device or the like for reading data stored in various storage media. The data I/F unit 1105 may be provided outside the computer 1100. In a case where the data I/F unit 1105 is provided outside the computer 1100, the data I/F unit 1105 may be connected to the computer 1100 via, for example, an interface such as USB.

The communication I/F unit 1106 may be a device for performing data communication via a network such as the Internet with a device outside the computer 1100 in a wired or wireless manner. The communication I/F unit 1106 may be provided outside the computer 1100. In a case where the communication I/F unit 1106 is provided outside the computer 1100, the communication I/F unit 1106 may be connected to the computer 1100 via, for example, an interface such as USB.

The display device 1107 may be a device for displaying various types of information. The display device 1107 may be, for example, a liquid crystal display, an organic electro-luminescence (EL) display, a display of a wearable device, or the like. The display device 1107 may be provided outside the computer 1100. In a case where the display device 1107 is provided outside the computer 1100, the display device 1107 may be connected to the computer 1100 via, for example, a display cable or the like. In addition, in a case where a touch panel is employed as the input I/F unit 1104, the display device 1107 may be integrated with the input I/F unit 1104.

An embodiment of the present invention has been described above. The information processing system 100 can acquire first document data including first table data and second document data including second table data, specify a correspondence between at least one first cell included in the first table data and at least one second cell included in the second table data, and specify a difference between the first table data and the second table data. As a result, the information processing system 100 can specify a point of difference between the table data in tabular form.

In addition, the information processing system 100 can output display data for displaying at least one of the first table data and the second table data with the difference highlighted to the user terminal 200. Furthermore, the information processing system 100 can output, to the user terminal 200, display data for displaying the first table data and the second table data side by side with the difference highlighted. As a result, the user can visually grasp a point of difference between the first table data and the second table data.

In addition, as correspondence specifying processing, the information processing system 100 can specify a non-corresponding cell that does not correspond between the first table data and the second table data and specify contents data included in the non-corresponding cell as a difference. As a result, the information processing system 100 can specify the non-corresponding cell as a point of difference, and the user can grasp the non-corresponding cell as a point of difference.

In addition, the information processing system 100 can perform first processing of associating at least one first representative cell included in a predetermined column of the first table data and at least one second representative cell included in a predetermined column of the second table data, and second processing of associating at least one first belonging cell included in a row of the first representative cell and at least one second belonging cell included in a row of the second representative cell. As a result, the information processing system 100 can associate cells even in a case where the first table data and the second table data are table data having different structures.

Furthermore, in a case where at least one of the at least one first representative cell and the at least one second representative cell is a vertically combined cell extending over a plurality of rows, the information processing system 100 can perform third processing of regarding table data including a plurality of cells located on the right of the vertically combined cell in the plurality of rows as the first table data or the second table data and performing the first processing and the second processing. As a result, the information processing system 100 can associate cells even in a case where at least one of the first table data and the second table data is table data including a vertically combined cell.

Furthermore, in a case where at least one of the at least one first representative cell and the at least one second representative cell includes a plurality of identical contents cells, the information processing system 100 can perform third processing of regarding table data including a plurality of cells located on the right of the plurality of identical contents cells as the first table data or the second table data, and performing the first processing and the second processing. As a result, the information processing system 100 can associate cells even in a case where at least one of the first table data and the second table data includes identical contents cells (for example, the same character string or blank cells).

Note that, in the present invention, a “unit” does not simply mean a physical means, but includes a case where a function of the “unit” is implemented by software. In addition, a function of one “unit” or device may be implemented by two or more physical means, devices, or pieces of software, and functions of two or more “units” or devices may be implemented by one physical unit, device, or piece of software.

Furthermore, the present embodiment is intended to facilitate understanding of the present invention, and is not intended to interpret the present invention in a limited manner. The present invention can be changed or improved without departing from the gist thereof, and the present invention also includes equivalents thereof.

What is claimed is:

1. An information processing method executed by a processor, the information processing method comprising:
acquiring first document data including first table data and second document data including second table data;
specifying a correspondence between at least one first cell included in the first table data and at least one second cell included in the second table data based on similarity of contents data included in cells; and
specifying a difference indicating a different part between the first table data and the second table data based on correspondence data generated by specifying the correspondence.

2. The information processing method according to claim 1, further comprising outputting display data for displaying at least one of the first table data and the second table data with the difference highlighted to a user terminal of a user.

3. The information processing method according to claim 2, wherein the outputting includes outputting the display data for displaying the first table data and the second table data side by side with the difference highlighted.

4. The information processing method according to claim 1, wherein the difference includes a difference between first contents data included in the first cell and second contents data included in the second cell.

5. The information processing method according to claim 1, wherein
the specifying the correspondence includes specifying a non-corresponding cell that does not correspond between the first table data and the second table data among the at least one first cell and the at least one second cell, and
the difference includes contents data included in the non-corresponding cell.

6. The information processing method according to claim 1, wherein
the specifying the correspondence includes:
first processing of associating at least one first representative cell included in a predetermined column of the first table data and at least one second representative cell included in a predetermined column of the second table data based on similarity of contents data included in cells; and
second processing of associating at least one first belonging cell included in a row of the at least one first representative cell and at least one second belonging cell included in a row of the at least one second representative cell associated with the at least one first representative cell based on similarity of contents data included in cells.

7. The information processing method according to claim 6, wherein the similarity is similarity based on evaluation according to a Levenshtein distance in contents data included in cells.

8. The information processing method according to claim 6, wherein
the specifying the correspondence further includes
third processing in which, in a case where at least one cell of the at least one first representative cell and the at least one second representative cell is a vertically combined cell obtained by combining cells vertically arranged over a plurality of rows, table data including a plurality of cells located on right of the vertically combined cell in the plurality of rows is regarded as the first table data or the second table data, and the first processing and the second processing are executed.

9. The information processing method according to claim 6, wherein
the specifying the correspondence further includes
third processing in which, in a case where at least one of the at least one first representative cell and the at least one second representative cell includes a plurality of identical contents cells including identical contents data in cells, table data including a plurality of cells located on right of the plurality of identical contents cells is regarded as the first table data or the second table data, and the first processing and the second processing are executed.

10. The information processing method according to claim 9, wherein the plurality of identical contents cells include a blank cell whose contents data is blank.

11. The information processing method according to claim 1, wherein the first document data and the second document data are legal documents.

12. An information processing system comprising at least one processor, wherein
the at least one processor is configured to:
acquire first document data including first table data and second document data including second table data;
specify a correspondence between at least one first cell included in the first table data and at least one second cell included in the second table data based on similarity of contents data included in cells; and
specify a difference indicating a different part between the first table data and the second table data based on correspondence data generated by specifying the correspondence.

13. A non-transitory computer-readable medium storing a program for causing a processor to execute:
acquiring first document data including first table data and second document data including second table data;
specifying a correspondence between at least one first cell included in the first table data and at least one second cell included in the second table data based on of similarity of contents data included in cells; and
specifying a difference indicating a different part between the first table data and the second table data based on correspondence data generated by specifying the correspondence.
